(19) United States
(12) Patent Application Publication
(10) Pub. No.: US 2017/0043626 A1
(43) Pub. Date: Feb. 16, 2017

(54) Tire Comprising Reduced Rubber Mixture Thicknesses and Sheathed Casing Framework Reinforcement Elements

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Laurent BUCHER, Clermont-Ferrand Cedex 9 (FR); Philippe LESOEURS, Clermont-Ferrand Cedex 9 (FR); Sébastien RIGO, Clermont-Ferrand Cedex 9 (FR); Aurore LARDJANE, Clermont-Ferrand Cedex 9 (FR); Sébastien NOEL, Clermont-Ferrand Cedex 9 (FR); François BARBARIN, Clermont-Ferrand Cedex 9 (FR)

(21) Appl. No.: 15/306,149

(22) PCT Filed: Apr. 23, 2015
(86) PCT No.: PCT/EP2015/058825

§ 371 Date: Oct. 24, 2016

(30) Foreign Application Priority Data
Apr. 25, 2014 (FR) 1453720

(51) Int. Cl. B60C 9/20; B60C 9/08; B60C 9/00

(52) U.S. Cl. CPC B60C 9/2006; B60C 9/0007; B60C 9/08; B60C 2009/0284

(57) ABSTRACT

A tire having a radial carcass reinforcement having at least one layer of metal reinforcing elements. The tire includes a crown reinforcement, itself radially capped by a tread. The tread is connected to two beads by two sidewalls. The reinforcing elements of at least one layer of the carcass reinforcement have at least one filamentary element and at least one sheath covering the at least one filamentary element. The at least one sheath includes at least one layer of a thermoplastic polymer composition. The thickness of rubber compound between the internal surface of the tire cavity and the point of a metal reinforcing element of the carcass reinforcement that is closest to the internal surface of the cavity is less than or equal to 3.8 mm.

The present invention relates to a tire having a radial carcass reinforcement, and more particularly a tire intended to equip vehicles that carry heavy loads and run at sustained speed, such as lorries, tractors, trailers or buses, for example.

In the tires of heavy duty type, the carcass reinforcement is generally anchored on either side in the area of the bead and is surmounted radially by a crown reinforcement made up of at least two layers that are superimposed and formed of threads or cords which are parallel in each layer and crossed from one layer to the next, forming angles of between 10° and 45° with the circumferential direction. Said working layers that form the working reinforcement may furthermore be covered with at least one layer, referred to as a protective layer, formed of reinforcing elements which are advantageously metallic and extensible and referred to as elastic reinforcing elements. It may also comprise a layer of metal threads or cords having low extensibility, forming an angle of between 45° and 90° with the circumferential direction, this ply, referred to as the triangulation ply, being located radially between the carcass reinforcement and the first crown ply, referred to as the working ply, formed of parallel threads or cords lying at angles not exceeding 45° in terms of absolute value. The triangulation ply forms a triangulated reinforcement with at least said working ply, this reinforcement having low deformation under the various stresses which it undergoes, the triangulation ply essentially serving to absorb the transverse compressive forces that act on all the reinforcing elements in the crown area of the tire.

In the case of tires for “heavy duty” vehicles, just one protective layer is usually present and its protective elements are, in the majority of cases, oriented in the same direction and with the same angle in terms of absolute value as those of the reinforcing elements of the radially outermost and therefore radially adjacent working layer.

The circumferential direction of the tire, or longitudinal direction, is the direction that corresponds to the periphery of the tire and is defined by the direction in which the tire runs.

The axis of rotation of the tire is the axis about which it turns in normal use.

A radial or meridian plane is a plane which contains the axis of rotation of the tire.

The circumferential mid-plane, or equatorial plane, is a plane which is perpendicular to the axis of rotation of the tire and divides the tire into two halves.

The transverse or axial direction of the tire is parallel to the axis of rotation of the tire. An axial distance is measured in the axial direction.

The radial direction is a direction that intersects the axis of rotation of the tire and is perpendicular thereto. A radial distance is measured in the radial direction. The expression “radially on the inside of or radially on the outside of, respectively” means “of which the radial distance, measured from the axis of rotation of the tire, is respectively less than or greater than”.

Some current tires, referred to as “road” tires, are intended to run at high speed and over increasingly long journeys, as a result of the improvement in the road network and of the growth of the motorway network throughout the world. The combination of conditions under which such a tire has to run undoubtedly allows an increase in the distance covered since tire wear is lower; however, the endurance of the tire is detrimentally affected. In order to allow one, or even two, retreadings of such tires in order to lengthen their life, it is necessary to retain a structure and notably a carcass reinforcement of which the endurance properties are sufficient to withstand said retreadings.

Prolonged running under particularly severe conditions of the tires thus constructed effectively results in limits appearing regarding the endurance of these tires.

The elements of the carcass reinforcement are notably subjected to bending and compressive stresses during running, which adversely affect their endurance. Specifically, the cords which form the reinforcing elements of the carcass layers are subjected to high stresses during the running of the tires, notably to repeated bending actions or variations in curvature, resulting in rubbing actions at the threads and thus in wear, and also in fatigue; this phenomenon is described as “fatigue fretting”.

In order to fulfil their role of strengthening the carcass reinforcement of the tire, said cords first of all have to exhibit good flexibility and high flexural endurance, this meaning in particular that their threads have a relatively small diameter, preferably less than 0.28 mm, more preferably less than 0.25 mm, generally smaller than that of the threads used in conventional cords for crown reinforcements of tires.

The cords of the carcass reinforcement are also subject to “fatigue corrosion” phenomena due to the very nature of the cords which favor the passage of, or even drain, corrosive agents such as oxygen and moisture. This is because the air or water which penetrates into the tire, for example when damaged by a cut or more simply as the result of the permeability, even though low, of the inner surface of the tire, can be conveyed by the channels formed within the cords by the very fact of their structure.

All of these fatigue phenomena, which are generally grouped together under the generic term of “fatigue fretting corrosion”, cause a progressive deterioration in the mechanical properties of the cords and can, for the most severe running conditions, affect the life of these cords.

In order to improve the endurance of these cords of the carcass reinforcement, it is known in particular to increase the thickness of the layer of rubber which forms the internal wall of the tire cavity in order to limit the permeability of said layer as much as possible. This layer is usually partly composed of butyl, so as to increase the airtightness of the tire. This type of material has the disadvantage of increasing the cost of the tire.

It is also known to modify the construction of said cords in order notably to increase their penetrability by the rubber and thus limit the dimension of the passage for the oxidizing agents.

Moreover, the use of tires on vehicles of the heavy duty type intended for road use, notably when mounted in a twin configuration on a driven axle or on trailers, leads to unwanted use in deflated mode. Specifically, analysis has revealed that tires are often used underinflated without the driver being aware of this. Underinflated tires are thus regularly used, covering not insignificant distances. A tire used in this way experiences greater deformation than under normal conditions of use and this may lead to carcass reinforcement cord deformation of the “buckling” type, which carries a high penalty notably in terms of ability to withstand the stresses associated with the inflation pressures.

In order to limit this problem associated with the risk of the buckling of the carcass-reinforcement reinforcing elements, it is known practice to use cords that are wrapped by an additional thread surrounding the cord and preventing any risk of buckling of the cord or of the threads of which the cord is composed. Tires produced in this way, although less at risk from damage associated with running at low inflation pressures, do have lessened flexural endurance performance notably because of the rubbing between the wrapping thread and the outer threads of the cord as the tire is deformed during running.

It is also known, in order to alleviate this problem of the buckling of the cords when running with an underinflated tire, to increase at least locally, in the regions facing the region of the carcass reinforcement likely to buckle, the thickness of the layer of rubber that forms the internal wall of the tire cavity. As explained above, an increase, even a local one, in the thickness of the layer of rubber separating the carcass reinforcement from the tire cavity leads to a higher tire cost.

The inventors thus set themselves the task of providing tires for heavy vehicles of the “heavy duty” type, the manufacturing cost of which is reduced and the performance, notably endurance performance, of which is improved notably from the viewpoint of the “fatigue corrosion” or “fatigue fretting corrosion” phenomena, whatever the running conditions, notably in terms of inflation and of load.

This aim has been achieved according to the invention by a tire having a radial carcass reinforcement made up of at least one layer of reinforcing elements, said tire comprising a crown reinforcement, itself radially capped by a tread, said tread being connected to two beads by two sidewalls, the reinforcing elements of at least one layer of the carcass reinforcement are made up of at least one filamentary element and at least one sheath covering said at least one filamentary element, said at least one sheath comprising at least one layer of a thermoplastic polymer composition, and the thickness of rubber compound between the internal surface of the tire cavity and the point of a metal reinforcing element of the carcass reinforcement that is closest to said internal surface of the cavity being less than or equal to 3.8 mm.

The thickness of rubber compound between the internal surface of the tire cavity and the point of a reinforcing element that is closest to said surface is equal to the length of the orthogonal projection of the end of that point of a reinforcing element that is closest to said surface onto the internal surface of the tire cavity.

The measurements of the thickness of rubber compound are carried out on a cross section of a tire, the tire thus being in a non-inflated state.

A filamentary element means any longilinear element of great length relative to its cross section, whatever the shape of the latter, for example circular, oblong, rectangular or square, or even flat, it being possible for this filamentary element to be twisted or wavy, for example. When it is circular, its diameter ranges preferably from 0.7 to 5 mm, more preferably from 0.7 to 2 mm.

A thermoplastic polymer composition means a composition comprising at least one polymer having the properties of a thermoplastic polymer. The composition may comprise other polymers, preferably thermoplastic polymers, possibly elastomers, and other non-polymer components.

An elastomer (or rubber, the two terms being considered to be synonymous) denotes any type of elastomer, be it of the diene type or the non-diene type, for example a thermoplastic elastomer.

Preferably, the elastomer is of the diene type and more preferably selected from the group consisting of polybutadienes (BR), synthetic polyisoprenes (IR), natural rubber (NR), butadiene copolymers, isoprene copolymers and the mixtures of these elastomers. Such copolymers are more preferably selected from the group consisting of stirene-butadiene copolymers (SBRs), isoprene-butadiene copolymers (BIRs), isoprene-stirene copolymers (SIRs), isoprene-butadiene-stirene copolymers (SBIRs) and the mixtures of such copolymers.

The inventors have been able to demonstrate that a tire thus produced according to the invention results in highly advantageous improvements in terms of the compromise between endurance and manufacturing costs. Specifically, the endurance properties with such a tire are at least as good as with the best solutions mentioned above, whether under normal running conditions or under underinflated running conditions. Moreover, since the thickness of the layer of rubber compound between the carcass reinforcement and the tire cavity is reduced in comparison with conventional tires and because this layer is one of the most expensive components of the tire, the cost of manufacturing the tire is lower than that of a conventional tire. The filamentary elements covered with a sheath comprising at least one layer of a thermoplastic polymer composition both make it possible to limit the risks associated with corrosion and appear to have an effect that counters the buckling of the cords, thus making it possible to best reduce the thickness of rubber compounds between the internal surface of the tire cavity and the carcass reinforcement. Specifically, the sheath constitutes an effective barrier to corrosive agents that are likely to pass into contact with the filamentary elements. In addition, its presence appears to make it possible to prevent buckling.

According to one preferred embodiment of the invention, with the rubber compound between the tire cavity and the reinforcing elements of the radially innermost carcass reinforcement layer being made up of at least two layers of rubber compound, the radially innermost layer of rubber compound has a thickness less than 1.7 mm. As explained above, this layer is usually partly composed of butyl, so as to increase the airtightness of the tire, and since this type of material has a not insignificant cost, the reduction in this layer is favorable. The thickness of the radially innermost layer of rubber compound is advantageously even greater than 0.9 mm.

More preferably according to the invention, the layer of rubber compound radially adjacent to the radially innermost layer of rubber compound has a thickness less than 1.7 mm. The thickness of this layer, the constituents of which notably allow oxygen from the air to be fixed, can also be reduced so as to further decrease the cost of the tire. The thickness of the layer of rubber compound radially adjacent to the radially innermost layer of rubber compound is advantageously even greater than 0.9 mm.

The thicknesses of each of these two layers are equal to the length of the orthogonal projection of a point of one surface onto the other surface of said layer.

According to the invention, the mean thickness of the sheath at the back of each filamentary element is preferably between 1 μm and 2 mm; it is advantageously greater than 10 μm and preferably greater than 35 μm; it is further advantageously less than 1 mm and preferably less than 200 μm.

The mean thickness of the sheath is measured over a total axial width of 10 cm on either side of the mid-plane of the tire (i.e. between −5 cm and +5 cm with respect to the mid-plane of the reinforced product) and averaged over the number of measurements carried out (i.e., for example, a total of 100 measurements if there are 10 reinforcing elements per cm). For each measurement, the thickness of the sheath is determined by halving the difference between the bulk of the reinforcing element and the bulk of the filamentary element in a direction perpendicular to the main direction, in this case the direction substantially parallel to the thickness of the carcass ply.

Advantageously according to the invention, the thermoplastic polymer composition comprises a thermoplastic polymer, a functionalized diene elastomer, a poly(p-phenylene ether) or a mixture of these materials.

Preferably, the functionalized diene elastomer is a thermoplastic stirene elastomer.

In one embodiment, the sheath comprises a single layer of the thermoplastic polymer composition. Alternatively, the sheath comprises several layers, at least one of them comprising a thermoplastic polymer composition.

Thus, the various materials and layers described in the applications WO2010/136389, WO2010/105975, WO2011/012521, WO2011/051204, WO2012/016757, WO2012/038340, WO2012/038341, WO2012/069346, WO2012/104279, WO2012/104280 and WO2012/104281 may be used for example.

According to one advantageous variant of the invention, the sheath is covered with a layer of an adhesive providing adhesion between the sheath and the elastomer matrix.

The adhesive used is for example of the RFL (resorcinol-formaldehyde-latex) type or, for example, as described in the publications WO2013017421, WO2013017422, WO2013017423.

According to one preferred embodiment, each filamentary element comprises an assembly of individual metal threads. Thus, the mechanical anchoring of the sheath around and in the assembly is favored.

Also preferably according to the invention, the filamentary elements of at least one layer of the carcass reinforcement are layered metal cords of [L+M] or [L+M+N] construction that are usable as reinforcing elements in a tire carcass reinforcement, having a first layer C1 of L threads of diameter d₁, with L ranging from 1 to 4, surrounded by at least one intermediate layer C2 of M threads of diameter d₂ wound together in a helix at a pitch p₂, with M ranging from 3 to 12, said layer C2 possibly being surrounded by an external layer C3 of N threads of diameter d₃ wound together in a helix at a pitch p₃, with N ranging from 8 to 20.

Preferably, the diameter of the threads of the first layer of the internal layer (C1) is between 0.10 and 0.5 mm and the diameter of the threads of the external layers (C2, C3) is between 0.10 and 0.5 mm.

Also preferably, the helical pitch at which said threads of the external layer (C3) are wound is between 8 and 25 mm.

Within the meaning of the invention, the pitch represents the length, measured parallel to the axis of the cord, at the end of which a thread having this pitch completes a full turn around the axis of the cord; thus, if the axis is sectioned by two planes perpendicular to said axis and separated by a length equal to the pitch of a thread of a layer forming the cord, the axis of this thread has, in these two planes, the same position on the two circles corresponding to the layer of the thread in question.

In the L+M+N construction according to the invention, the intermediate layer C2 preferably has six or seven threads, and the cord in accordance with the invention then has the following preferred features (d₁, d₂, d₃, p₂ and p₃ in mm):
(i) 0.10<d₁<0.28;
(ii) 0.10<d₂<0.25;
(iii) 0.10<d₃<0.25;
(iv) M=6 or M=7;
(v) 5π(d₁+d₂)<p₂≦p₃<5π(d₁+2d₂₊d₃);
(vi) the threads of said layers C2, C3 are wound in the same direction of twisting (S/S or Z/Z).

Preferably, feature (v) is such that p₂=p₃, such that the cord is said to be compact, bearing in mind also feature (vi) (threads of layers C2 and C3 wound in the same direction).

According to feature (vi), all the threads of the layers C2 and C3 are wound in the same direction of twisting, that is to say either in the S direction (“S/S” arrangement) or in the Z direction (“Z/Z” arrangement). Winding the layers C2 and C3 in the same direction advantageously makes it possible, in the cord in accordance with the invention, to minimize rubbing between these two layers C2 and C3 and thus the wearing of the threads of which they are made (since there is no longer cross contact between the threads).

Preferably, the cord of the invention is a layered cord with a construction referred to as 1+M+N, that is to say that its internal layer C1 is made up of a single thread.

Advantageously also, the ratios (d₁/d₂) are preferably fixed within given limits, according to the number M (6 or 7) of threads in the layer C2, as follows:
for M=6: 0.9<(d₁/d2)<1.3;
for M=7: 1.3<(d₁/d₂)<1.6.

Too low a value of the ratio d₁/d₂ may be detrimental to wear between the internal layer and the threads of the layer C2. Too high a value on the other hand may impair the compactness of the cord, for a strength level which is fairly unchanged in definitive terms, and may also impair flexibility; the increased rigidity of the internal layer C1 due to too high a diameter d₁ could also be detrimental to the very feasibility of the cord, during cabling operations.

The threads of the layers C2 and C3 may have diameters that are identical or different from one layer to the other. Use is preferably made of threads of the same diameter (d₂=d₃), notably in order to simplify the cabling method and keep costs down.

The maximum number Nₘₐₓ of threads that are able to be wound into a single saturated layer C3 around the layer C2 is of course dependent on many parameters (the diameter d₁ of the internal layer, the number M and diameter d₂ of the threads of the layer C2, the diameter d₃ of the threads of the layer C3).

The invention is preferably implemented using a cord chosen from cords of structure 1+6+10, 1+6+11, 1+6+12, 1+7+11, 1+7+12 or 1+7+13.

The invention may also be implemented for example using a cord chosen from cords of structure 1+5, 1+6, 2+7, 2+8, 3+8 or 3+9.

Preferably, the assembly does not have a wrapping thread wound around the external layer.

Generally, the invention can be implemented, in order to form the above-described cords of the carcass reinforcement, with any type of metal threads.

By definition, an individual metal thread means a monofilament made up predominantly (i.e. more than 50% of its mass) or entirely (100% of its mass) of a metallic material. Each monofilament is preferably made of steel, more preferably pearlitic (or ferritic-pearlitic) carbon steel referred to as “carbon steel” below, or else made of stainless steel (by definition steel comprising at least 11% chromium and at least 50% iron).

When a carbon steel is used, its carbon content (% by weight of steel) is preferably between 0.5% and 0.9%. Use is preferably made of a steel of the normal tensile (NT) or high tensile (HT) steel cord type, the tensile strength (Rm) of which is preferably higher than 2000 MPa, more preferably higher than 2500 MPa. The measurements are taken under tensile testing according to standard ISO 6892-1, 2009.

In one preferred embodiment, each individual metal thread has a diameter ranging from 0.10 mm to 0.35 mm, preferably from 0.12 mm to 0.26 mm, and more preferably from 0.14 mm to 0.22 mm.

According to a variant embodiment of the invention, the crown reinforcement of the tire is formed of at least two working crown layers of inextensible reinforcing elements that are crossed from one layer to the other and form, with the circumferential direction, angles of between 10° and 45°.

According to other variant embodiments of the invention, the crown reinforcement furthermore has at least one layer of circumferential reinforcing elements.

One preferred embodiment of the invention also provides for the crown reinforcement to be supplemented radially on the outside by at least one additional layer, referred to as a protective layer, of reinforcing elements, referred to as elastic reinforcing elements, that are oriented with respect to the circumferential direction at an angle of between 10° and 45° and in the same direction as the angle formed by the inextensible elements of the working layer radially adjacent to it.

The protective layer may have an axial width less than the axial width of the least wide working layer. Said protective layer may also have an axial width greater than the axial width of the least wide working layer, such that it covers the edges of the least wide working layer and, if the radially uppermost layer is the least wide layer, such that it is coupled, in the axial extension of the additional reinforcement, to the widest working crown layer over an axial width and is then decoupled, axially on the outside, from said widest working layer by profiled elements with a thickness of at least 2 mm. In the abovementioned case, the protective layer formed of elastic reinforcing elements may, on the one hand, be decoupled if required from the edges of said least wide working layer by profiled elements with a thickness substantially less than the thickness of the profiled elements separating the edges of the two working layers, and, on the other hand, have an axial width less than or greater than the axial width of the widest crown layer.

According to any one of the embodiments of the invention mentioned above, the crown reinforcement may furthermore be supplemented, radially on the inside between the carcass reinforcement and the radially internal working layer closest to said carcass reinforcement, by a triangulation layer made of metal inextensible reinforcing elements that are made of steel and form, with the circumferential direction, an angle of more than 60° and in the same direction as the angle formed by the reinforcing elements of the radially closest layer of the carcass reinforcement.

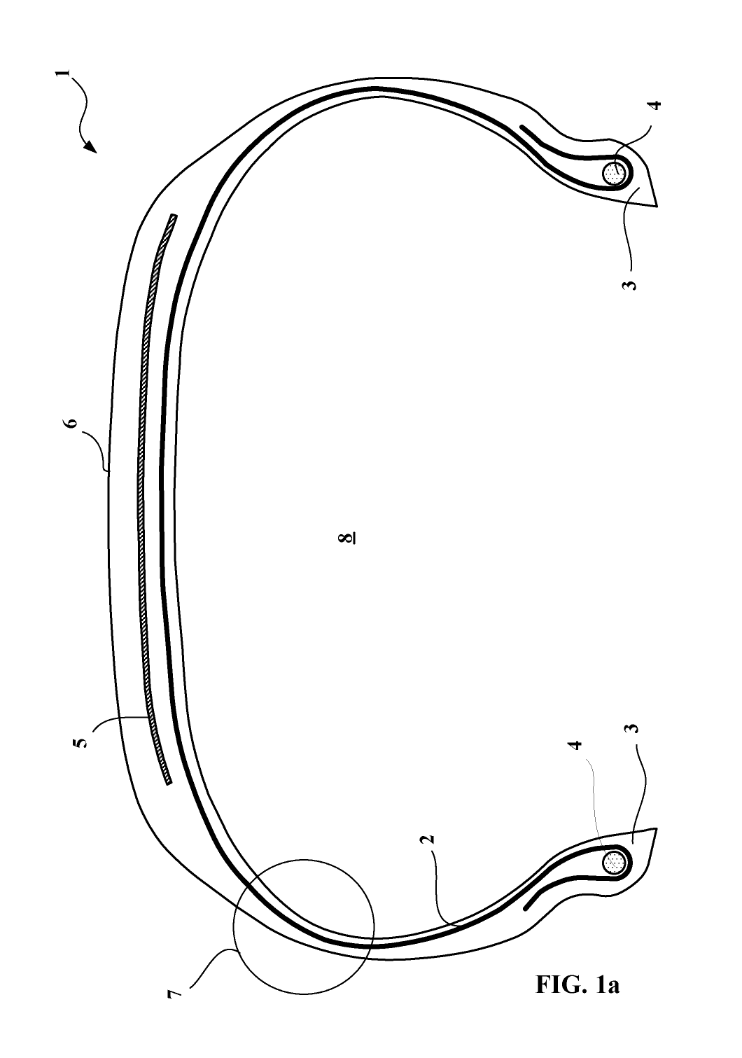

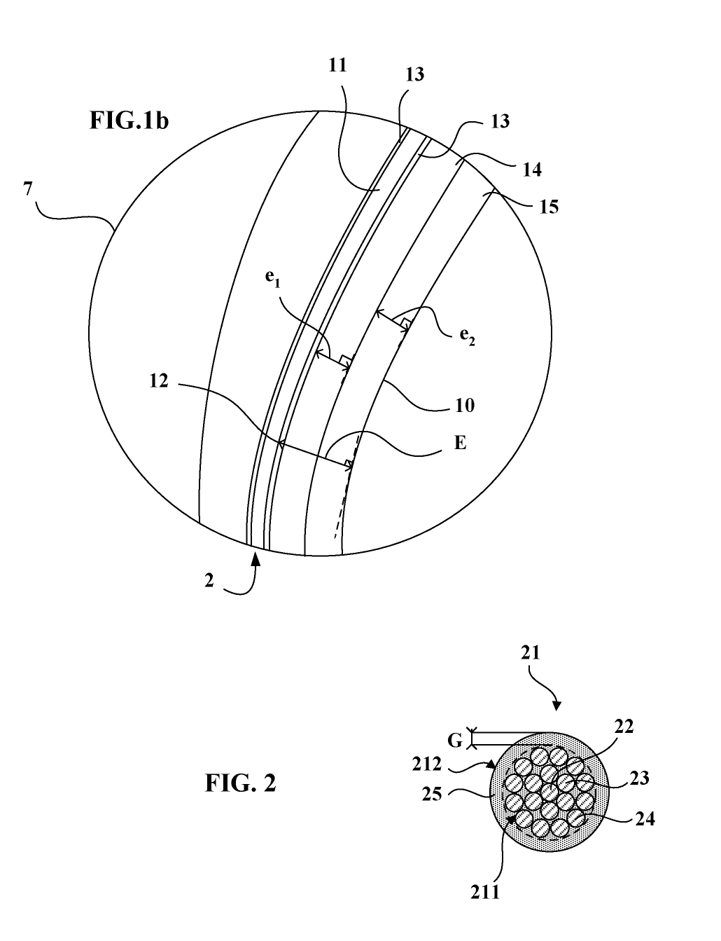

Further details and advantageous features of the invention will become apparent in the following from the description of the exemplary embodiments of the invention, with reference to FIGS. 1 to 3 in which:

FIG. 1a is a schematic meridian view of a tire according to one embodiment of the invention,

FIG. 1b is an enlarged partial view of a part of the schematic view of FIG. 1a,

FIG. 2 is a schematic view in cross section of a carcass reinforcement cord of the tire in FIG. 1.

In order to make them easier to understand, the figures are not shown to scale.

In FIGS. 1a and 1b, the tire 1, of size 315/70 R 22.5, comprises a radial carcass reinforcement 2 anchored in two beads 3 around bead wires 4. The carcass reinforcement 2 is formed of a single layer of metal cords 11 and of two calendering layers 13. The carcass reinforcement 2 is hooped by a crown reinforcement 5, itself capped by a tread 6. The crown reinforcement 5 is formed radially, from the inside towards the outside:
of a first working layer formed of non-wrapped inextensible 11.35 metal cords which are continuous across the entire width of the ply, oriented at an angle of 18°,
of a second working layer formed of non-wrapped inextensible 11.35 metal cords which are continuous across the entire width of the ply, oriented at an angle of 18° and crossed with the metal cords of the first working layer,
of a protective layer formed of elastic 6×35 metal cords.

This combination of layers constituting the crown reinforcement 5 is not shown in detail in the figures.

FIG. 1b illustrates an enlargement of region 7b in FIG. 1a and notably indicates the thickness E of rubber compound between the internal surface 10 of the tire cavity 8 and the point 12 of a reinforcing element 11 that is closest to said surface 10. This thickness E is equal to the length of the orthogonal projection of the point 12 of a reinforcing element 11 that is closest to said surface 10 onto the surface 10. This thickness E is the sum of the thicknesses of the various rubber compounds placed between said reinforcing element 11 of the carcass reinforcement 2; it corresponds, on the one hand, to the thickness of the calendering layer 13 radially on the inside of the carcass reinforcement and, on the other hand, to the thicknesses e₁, e₂ of the various layers 14, 15 of rubber compound that form the inner wall of the tire 1. These thicknesses e₁, e₂ are moreover equal to the length of the orthogonal projection of a point on one surface onto the other surface of the respective layer 14 or 15 in question.

The thickness measurements are taken on a cross section of the tire, the latter consequently not being fitted or inflated.

The value E measured is equal to 3.8 mm.

The values of e₁ and e₂ are respectively equal to 1.7 mm and 1.7 mm.

FIG. 2 illustrates a schematic depiction of a reinforcing element 21 of the carcass reinforcement. It comprises at least one filamentary element 211 and at least one sheath 212 covering the filamentary element 211. The sheath 212 comprises at least one layer 25 of a thermoplastic polymer composition.

The filamentary element 211 is made up of an assembly of individual metal threads.

The filamentary element 211 is a non-wrapped layered cord of 1+6+12 structure, made up of a central nucleus formed of a thread 22, an intermediate layer formed of six threads 23 and an external layer formed of twelve threads 24.

It has the following features (d and p in mm):
1+6+12 structure;
d₁=0.20 (mm);
d₂=0.18 (mm);
p₁=10 (mm);
d₃=0.18 (mm);
p₂=10 (mm);
(d₂/d₃)=1;
   with d₂ and p₂ respectively the diameter and the helical pitch of the intermediate layer and d₃ and p₃ respectively the diameter and the helical pitch of the threads of the external layer.

The sheath 212 has a mean thickness G at the back of each filamentary element 211 equal to 150 μm.

The layer 25 of the thermoplastic polymer composition comprises a thermoplastic polymer, a functionalized diene elastomer, a poly(p-phenylene ether) or a mixture of these materials. In this case, the thermoplastic polymer composition comprises a thermoplastic polymer, for example polyamide 66. Optionally, the thermoplastic polymer composition may comprise a functionalized diene elastomer, for example a stirene thermoplastic comprising an epoxide, carbonyl, anhydride or ester function and/or a poly(p-phenylene ether).

The layer 25 of the thermoplastic polymer composition can also advantageously be covered with a layer of adhesive (not shown in FIG. 2) providing adhesion.

Tests have been carried out on tires produced according to the invention in accordance with the depiction in FIGS. 1 and 2, and other tests have been carried out with what are referred to as reference tires.

These reference tires differ from the tires according to the invention by way of carcass reinforcement cords that do not have the sheath 212 and by the fact that the thickness E of rubber compound between the internal surface of the tire cavity and the point of a reinforcing element that is closest to said surface is equal to 5.5 mm, each of the thicknesses e₁ and e₂ being equal to 2.5 mm.

Rolling road endurance tests were carried out on a test machine which applies a load of 4415 daN and a speed of 40 km/h on the tires, with oxygen-doped inflation of the tires. The tests were carried out for the tires according to the invention under conditions identical to those applied to the reference tires. The running operations were halted as soon as the tires exhibit carcass reinforcement degradation or after a given distance covered.

The tests thus carried out showed that the distances covered during each of these tests are favorable for the tires according to the invention; specifically, some of the tires exhibited degradation of the reinforcing elements of the carcass reinforcement while, for others, the tests had to be halted on account of excessive degradation. As far as the tires according to the invention are concerned, for the same distances covered, the reinforcing elements of the carcass reinforcement did not exhibit any damage.

Other endurance tests with running on a drive axle of a vehicle were carried out, with the tires being subjected to a load of 3680 daN and a speed of 40 km/h, with the tires inflated to 0.2 bar. The tests were carried out for the tires according to the invention under conditions identical to those applied to the reference tires. The running operations are carried out over a distance of 12 000 km or are halted as soon as the tires exhibit carcass reinforcement degradation.

The tests thus carried out showed that the distances covered during each of these tests are substantially equivalent for the tires according to the invention and the reference tires.

Moreover, the manufacturing costs of the tires according to the invention are not as high, the cost of materials being 6% lower in the case of the tires according to the invention.

Moreover, the tires according to the invention have the advantage of being less heavy, with a 5% lightening of weight compared with the reference tires.

1. A tire having a radial carcass reinforcement comprised of at least one layer of metal reinforcing elements, said tire comprising a crown reinforcement, itself radially capped by a tread, said tread being connected to two beads by two sidewalls, wherein the reinforcing elements of at least one layer of the carcass reinforcement are comprised of at least one filamentary element and at least one sheath covering said at least one filamentary element, said at least one sheath comprising at least one layer of a thermoplastic polymer composition, and wherein the thickness of rubber compound between the internal surface of the tire cavity and the point of a metal reinforcing element of the carcass reinforcement that is closest to said internal surface of the cavity is less than or equal to 3.8 mm.

2. The tire according to claim 1, the rubber compound between the tire cavity and the reinforcing elements of the radially innermost carcass reinforcement layer being comprised of at least two layers of rubber compound, wherein the radially innermost layer of rubber compound has a thickness less than 1.7 mm.

3. The tire according to claim 1, the rubber compound between the tire cavity and the reinforcing elements of the radially innermost carcass reinforcement layer being comprised of at least two layers of rubber compound, wherein the layer of rubber compound radially adjacent to the radially innermost layer of rubber compound has a thickness less than 1.7 mm.

4. The tire according to claim 1, wherein the mean thickness of the sheath at the back of each filamentary element is between 1 μm and 2 mm.

5. The tire according to claim 1, wherein the thermoplastic polymer composition comprises a thermoplastic polymer, a functionalized diene elastomer, a poly(p-phenylene ether) or a mixture of these materials.

6. The tire according to claim 1, wherein each filamentary element comprises an assembly of individual metal threads.

7. The tire according to claim 1, wherein the metal reinforcing elements of at least one layer of the carcass reinforcement are layered metal cords of [L+M] or [L+M+N] construction that are usable as reinforcing elements in a tire carcass reinforcement, having a first layer C1 of L threads of diameter d₁, with L ranging from 1 to 4, surrounded by at least one intermediate layer C2 of M threads of diameter d₂ wound together in a helix at a pitch p₂, with M ranging from 3 to 12, said layer C2 being surrounded by an external layer C3 of N threads of diameter d₃ wound together in a helix at a pitch p₃, with N ranging from 8 to 20.

8. The tire according to claim 7, wherein the diameter of the threads of the first layer (C1) is between 0.10 and 0.5 mm, and wherein the diameter of the threads of the layers (C2, C3) is between 0.10 and 0.5 mm.

9. The tire according to claim 7, wherein the helical pitch at which said threads of the external layer (C3) are wound is between 8 and 25 mm.

10. The tire according to claim 1, wherein the crown reinforcement is formed of at least two working crown layers of inextensible reinforcing elements that are crossed from one layer to the other and form, with the circumferential direction, angles of between 10° and 45°.

11. The tire according to claim 1, wherein the crown reinforcement furthermore has at least one layer of circumferential reinforcing elements.

12. The tire according to claim 1, wherein the crown reinforcement is supplemented radially on the outside by at least one additional ply, referred to as a protective ply, of reinforcing elements, referred to as elastic reinforcing elements, that are oriented with respect to the circumferential direction at an angle of between 10°and 45° and in the same direction as the angle formed by the inextensible elements of the working ply radially adjacent to it.

13. The tire according to claim 1, wherein the crown reinforcement also has a triangulation layer formed of metal reinforcing elements that form angles of more than 60° with the circumferential direction.
